(19) United States
(12) Patent Application Publication
(10) Pub. No.: US 2015/0269759 A1
(43) Pub. Date: Sep. 24, 2015

(54) IMAGE PROCESSING APPARATUS, IMAGE PROCESSING SYSTEM, AND IMAGE PROCESSING METHOD

(71) Applicant: KABUSHIKI KAISHA TOSHIBA, Tokyo (JP)

(72) Inventors: Masahiro SEKINE, Tokyo (JP); Kaoru SUGITA, Tokyo (JP); Masashi NISHIYAMA, Kawasaki (JP)

(21) Appl. No.: 14/564,425

(22) Filed: Dec. 9, 2014

(30) Foreign Application Priority Data
Mar. 20, 2014 (JP) 2014-058944

(51) Int. Cl. G06T 11/60; G06T 19/20; G06T 19/00; H04N 7/18; G06T 1/00

(52) U.S. Cl. CPC G06T 11/60; H04N 7/188; G06T 1/0007; G06T 19/006; G06T 19/20; G06T 2211/428; G06T 2210/16; G06T 2219/2004

(57) ABSTRACT

According to an embodiment, an image processing apparatus includes a first acquirer, a first generator, and a storage controller. The first acquirer acquires a first clothing image of a piece of clothing to be synthesized. The first generator generates a second clothing image by editing at least one of a size, a shape, and a position of the piece of clothing in the first clothing image. The storage controller stores the second clothing image in a storage.

### CROSS-REFERENCE TO RELATED APPLICATION(S)

This application is based upon and claims the benefit of priority from Japanese Patent Application No. 2014-058944, filed on Mar. 20, 2014; the entire contents of which are incorporated herein by reference.

### FIELD

Embodiments described herein relate generally to an image processing apparatus, an image processing system, and an image processing method.

### BACKGROUND

A technology for displaying a virtual image of a subject wearing a piece of clothing has been disclosed. For example, a technology for displaying a synthetic image of a subject trying on a piece of clothing has been disclosed.

Conventionally practiced is storing a clothing image acquired by taking a picture of the clothing in a storage, and using the clothing image as it is in an image synthesized with a subject image. It has been therefore necessary to apply various types of editing to the clothing image before synthesizing the clothing image to a subject image so that the subject wearing the piece of clothing looks natural in the resultant synthetic image. Generating a synthetic image of a clothing image and a subject image in a simplified manner has been therefore conventionally difficult.

### BRIEF DESCRIPTION OF THE DRAWINGS

FIG. 1 is a block diagram illustrating the functional configuration of an image processing system;

FIG. 2 is an exemplary schematic of a data structure of a clothing DB;

FIGS. 3A to 3C are schematic of exemplary reference position information;

FIG. 4 is a schematic of an exemplary first clothing image;

FIG. 5 is a schematic for explaining a second clothing image;

FIG. 6 is a schematic for explaining a rotation angle;

FIGS. 7A and 7B are schematics for explaining calculation of an enlargement or reduction ratio;

FIG. 8 is a schematic for explaining calculation of a deformation ratio;

FIG. 9A is a schematic of an example of the first clothing image;

FIGS. 9B and 9C are schematics of examples of second clothing images;

FIG. 10 is a flowchart of image processing;

FIG. 11 is a block diagram illustrating the functional configuration of another image processing system;

FIG. 12 is a schematic of the image processing system; and

FIG. 13 is a block diagram illustrating an exemplary hardware configuration.

### DETAILED DESCRIPTION

According to an embodiment, an image processing apparatus includes a first acquirer, a first generator, and a storage controller. The first acquirer acquires a first clothing image of a piece of clothing to be synthesized. The first generator generates a second clothing image by editing at least one of a size, a shape, and a position of the piece of clothing in the first clothing image. The storage controller stores the second clothing image in a storage.

Various embodiments will now be explained in detail with reference to the accompanying drawings.

### First Embodiment

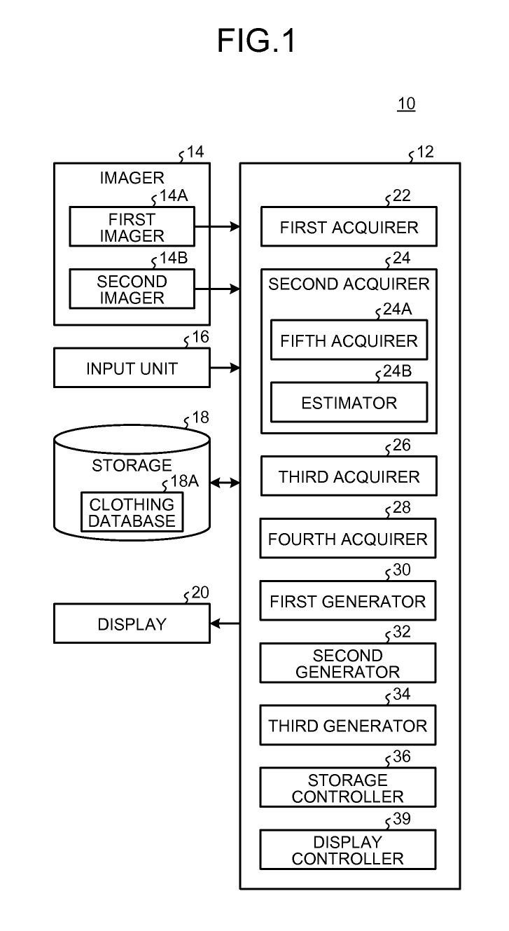

FIG. 1 is a block diagram illustrating the functional configuration of an image processing system 10 according to a first embodiment. The image processing system 10 includes an image processing apparatus 12, an imager 14, an input unit 16, a storage 18, and a display 20. The imager 14, the input unit 16, the storage 18, and the display 20 are connected to the image processing apparatus 12 in a manner enabling signals to be exchanged.

In the image processing system 10 according to the first embodiment, the image processing apparatus 12 is separately provided from the imager 14, the input unit 16, the storage 18, and the display 20. In the image processing system 10, however, the image processing apparatus 12 may be integrated with at least one of the imager 14, the input unit 16, the storage 18, and the display 20.

The imager 14 captures and acquires a first image of a first subject. The imager 14 outputs the captured first image of the first subject to the image processing apparatus 12.

The first subject is a subject who is to wear a piece of clothing. The first subject may be any subject who is to wear a piece of clothing, and may be a living or non-living thing. A living thing may be a person, as an example, as well as an animal such as a dog or a cat. A non-living thing may be a mannequin in a shape of a human or an animal, or various objects without limitation.

A piece of clothing is an item that can be worn by a subject. Examples of the clothing include a jacket, a skirt, a pair of trousers, shoes, and a hat, but clothing is not limited to a jacket, a skirt, a pair of trousers, shoes, and a hat. The term “subject” generally refers to any subject of which image is to be captured, including the first subject and a second subject described later.

In the first embodiment, the imager 14 includes a first imager 14A and a second imager 14B.

The first imager 14A acquires a color image of the first subject by capturing an image of the first subject.

A color image is a bit map image. A color image of the first subject is an image of which each pixel is specified with a pixel value indicating a color or luminance. The first imager 14A is a known camera device capable of capturing a color image.

The second imager 14B acquires a depth map of the first subject.

A depth map is sometimes referred to as a distance image. A depth map of the first subject is an image of which each pixel is specified with a distance from the second imager 14B that captured the image of the first subject. In the first embodiment, the depth map of the first subject may be created by applying a known process such as stereo matching to a color image of the first subject, or may be acquired by causing the second imager 14B to capture an image in the same conditions as those in which the color image of the first subject is captured. The second imager 14B is a known camera device capable of acquiring a depth map.

In the first embodiment, the first imager 14A and the second imager 14B capture images of the subject at the same timing. The first imager 14A and the second imager 14B are controlled by a controller not illustrated, for example, so as to capture images synchronously at the same timing. The imager 14 then successively outputs the depth maps of the first subject and the subject images of the first subject including the color images of the first subject to the image processing apparatus 12.

In the first embodiment, the camera coordinate system of the first imager 14A is explained to be the same as that of the second imager 14B. When the camera coordinate system of the first imager 14A is different from that of the second imager 14B, the image processing apparatus 12 converts the coordinate system of one of the cameras into that of the other before performing each process.

In the first embodiment, the first subject image is explained to include a color image of the first subject and a depth map of the first subject, but the first image is not limited thereto. For example, the first subject image may also include skeleton information described later.

The display 20 is a device for displaying various images. The display 20 is a display device such as a liquid crystal display (LCD). The image processing system 10 may be provided with the display 20.

The input unit 16 receives user inputs. A term “user” generally refers to any operator.

The input unit 16 is means for allowing users to make various operational inputs. Examples of the input unit 16 include one or any combination of a mouse, a button, a remote controller, a keyboard, a voice recognition device such as a microphone, and an image recognition device. When an image recognition device is used as the input unit 16, the device may receive gestures of users facing the input unit 16 as various user instructions. In such a configuration, instruction information corresponding to movements such as gestures is stored in advance in the image recognition device, and the image recognition device may read the instruction information corresponding to a recognized gesture, and accept the user operation instruction.

The input unit 16 may also be a communication device for receiving a signal indicating a user operation instruction from an external device such as a mobile terminal that transmits various types of information. In such a configuration, the input unit 16 may receive a signal indicating an operation instruction from the external device, as an operation instruction issued by a user.

The input unit 16 may be integrated with the display 20. Specifically, the input unit 16 and the display 20 may be provided as a user interface (UI) having an input function and a display function. An example of such an UI includes an LCD with a touch panel.

The storage 18 stores therein various types of data. In the first embodiment, the storage 18 stores therein various types of data such as a clothing database (DB) 18A, a first range, and a second range. The first range and the second range will be described later in detail.

The clothing DB 18A is a DB storing therein a clothing image to be synthesized. The clothing DB 18A may be any storage in which various types of information described later are stored in an association manner, without limitation to a DB.

The image processing apparatus 12 registers and updates the various types of data stored in the clothing DB 18A through the process described later.

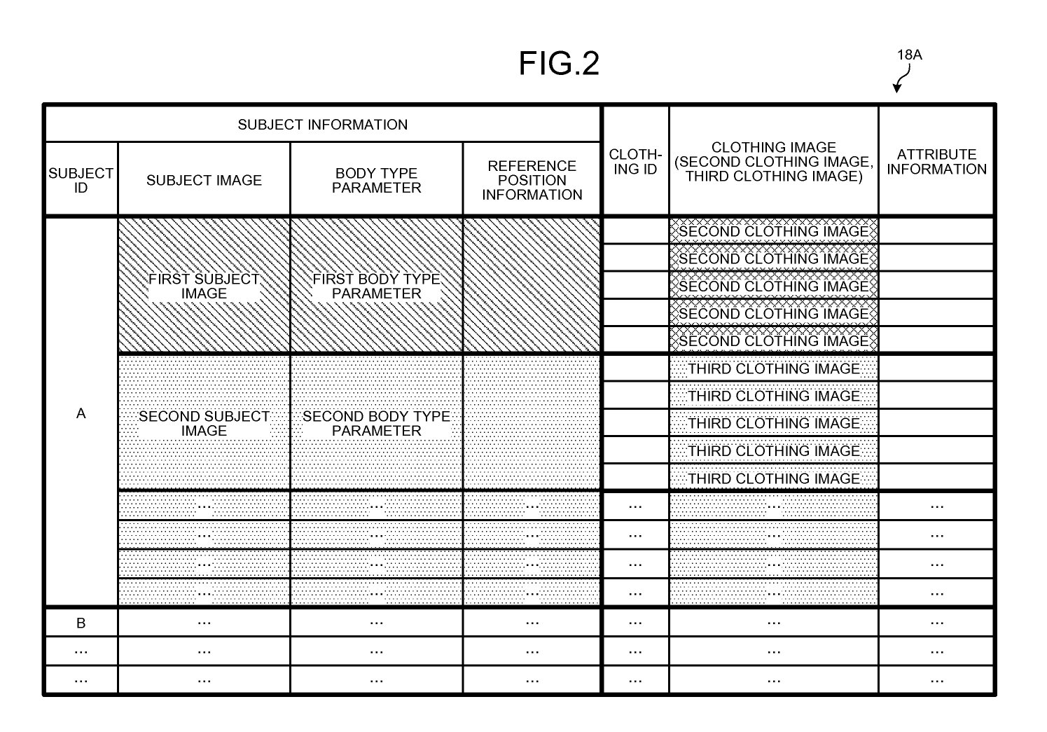

FIG. 2 is an exemplary schematic of a data structure of the clothing DB 18A. The clothing DB 18A is a piece of information in which subject information, a clothing ID, a clothing image, and attribute information are associated with one another.

The subject information includes subject identification information (ID), a subject image, a body type parameter, and reference position information.

A subject ID is a piece of information capable of uniquely identifying a subject.

A subject image includes a first subject image and a second subject image. A first subject image is a first image of a first subject acquired from the imager 14. A second subject image is a subject image generated by causing the image processing apparatus 12 to edit the first subject image (details of which will be described later).

The body type parameter is a piece of information indicating the body type of the subject. The body type parameter may include one or more parameters. The parameter is a measurement of one or more locations of a human body. The measurement is not limited to an actual measurement, and may also include an estimation of a measurement and any other value corresponding to the measurement (e.g., any value entered by a user).

In the first embodiment, a parameter is a measurement corresponding to each part of the human body measured before a piece of clothing is tailored or purchased. Specifically, the body type parameter includes at least one parameter of a chest circumference, a waist circumference, a hip circumference, a height, and a shoulder width. The body type parameter is not limited to these listed above. For example, the body type parameter may also include parameters such as a sleeve length, an inseam, the positions of apexes in a three dimensional computer graphics (CG) model, and positions of joints in a skeleton.

The body type parameter includes a first body type parameter and a second body type parameter. The first body type parameter is a body type parameter representing a body type of a first subject. A second body type parameter is a body type parameter representing a body type of a second subject.

The reference position information is a piece of information used in adjusting positions before synthesizing. The synthesizing means synthesizing a clothing image to a subject image of a subject. A term “subject image” generally refers to any image representing a subject. The reference position information is used as a reference in adjusting the positions before synthesizing.

Examples of reference position information include a feature region, a contour line, and a feature point.

A feature region is a region allowing the shape of a subject to be estimated in the subject image. Examples of a feature region includes a shoulder region corresponding to the shoulders, a hip region corresponding to the hip, and feet regions corresponding to the feet of a human body, but examples are not limited thereto.

A contour line is the contour line of a region allowing the shape of a subject to be estimated from a subject image. When the region allowing the shape of a subject to be estimated is the shoulder region of a human body, for example, the contour line in the subject image is a linear image following the contour line of the shoulder region.

A feature point is a point allowing the shape of a subject to be estimated in the subject image. Examples of a feature point include the positions of joints in a human body, or the center of a feature region. A feature point may also be the position corresponding to the center between the shoulders of a human body, for example. Examples of a feature point are not limited to those listed above. A feature point is represented by the positional coordinates of an image.

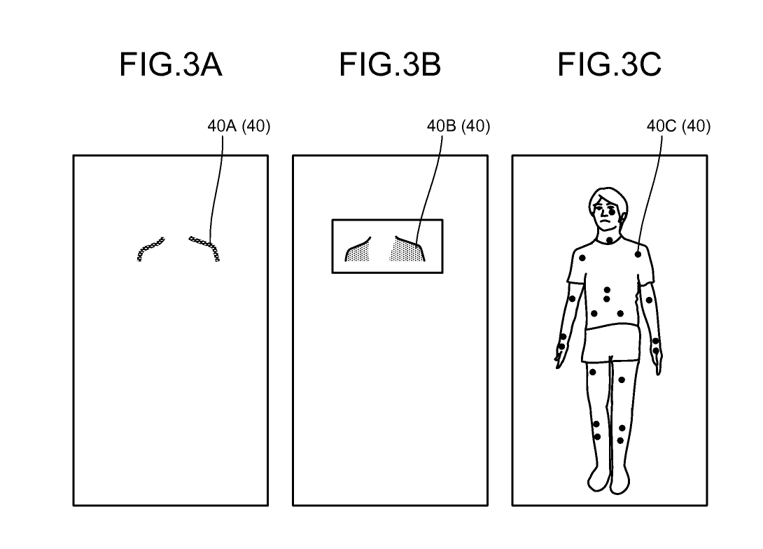

FIGS. 3A to 3C are schematic of exemplary reference position information 40. FIG. 3A is a schematic of an example of a contour line 40A. In FIG. 3A, the contour lines of the shoulders of a human body are provided as an example of the contour line 40A. FIG. 3B is a schematic of an example of a feature region 40B. In FIG. 3B, the shoulder regions of a human body are provided as an example of the feature region 40B. FIG. 3C is a schematic of an example of a feature point 40C. In FIG. 3C, the points corresponding to the joints of a human body are provided as an example of the feature point 40C.

Any information may be used as the reference position information as long as such information serves as a reference in adjusting the images before generating a synthetic image, and examples are not limited to a feature region, a contour line, and a feature point.

Referring back to FIG. 2, the clothing DB 18A stores therein one piece of reference position information in a manner associated with one subject image and one body type parameter. In other words, the clothing DB 18A stores therein one piece of reference position information in a manner associated with one body type parameter.

A clothing ID (clothing identification information) is a piece of information for uniquely identifying a piece of clothing. Examples of a clothing ID include the product number and the name of a piece of clothing, but without limitation. An example of the product number is a known Japanese Article Number (JAN) code. An example of the name is a product name of the clothing.

A clothing image is an image of a piece of clothing. The clothing image is an image of which each pixel is specified with a pixel value indicating a color, luminance, or the like of the clothing. A clothing image includes a second clothing image and a third clothing image. A second clothing image is a clothing image generated by causing the image processing apparatus 12 to edit a first clothing image (details of which will be described later). A third clothing image is a clothing image generated by causing the image processing apparatus 12 to edit a second clothing image (details of which will be described later).

The attribute information is a piece of information indicating an attribute of a piece of clothing identified by the corresponding clothing ID. Examples of the attribute information include the type, the size, the name, the manufacturer (e.g., brand name), the shape, the color, the materials, and the price of the clothing. The attribute information may also include the subject ID of a corresponding first subject, a first editing value (details of which will be described later) used in generating a second clothing image from a first clothing image, and a second editing value (details of which will be described later) used in generating a third clothing image from a second clothing image.

As illustrated in FIG. 2, the clothing DB 18A stores a set of a subject image, a body type parameter, and a piece of reference position information in a manner associated with a plurality of clothing images (one or more second clothing images, one or more third clothing images).

The clothing DB 18A may be any information in which a set of one subject image, one body type parameter, and a piece of reference position information is associated with a plurality of clothing images. In other words, the clothing DB 18A may not include at least one of the subject ID, the clothing ID, and the attribute information. The clothing DB 18A may also be any information in which other types of information are further associated.

Referring back to FIG. 1, the image processing apparatus 12 is a computer including a central processing unit (CPU), a read-only memory (ROM), and a random access memory (RAM). The image processing apparatus 12 may include any other circuit other than a CPU.

The image processing apparatus 12 includes a first acquirer 22, a second acquirer 24, a third acquirer 26, a fourth acquirer 28, a first generator 30, a second generator 32, a third generator 34, a storage controller 36, and a display controller 39.

The first acquirer 22, the second acquirer 24, the third acquirer 26, the fourth acquirer 28, the first generator 30, the second generator 32, the third generator 34, the storage controller 36, and the display controller 39 may be implemented entirely or partially by causing a processor such as a CPU to execute a computer program, that is, implemented as software, as hardware such as an integrated circuit (IC), or a combination of software and hardware.

The third acquirer 26 acquires a first subject image of a first subject. The third acquirer 26 acquires a first subject image from the imager 14. The third acquirer 26 may also acquire a first subject image from an external device not illustrated over a network, for example. The third acquirer 26 may also acquire a first subject image by reading a first subject image stored in the storage 18 in advance.

In an example explained hereunder in the first embodiment, the third acquirer 26 acquires a first subject image from the imager 14.

It is preferable for the first subject to be wearing a piece of clothing revealing the body line of the first subject (e.g., underwear) when the image of the first subject is captured. By acquiring a first subject image of a first subject wearing a piece of clothing revealing the body line of the first subject (e.g., underwear), the process of estimating a first body type parameter and the process of calculating reference position information described later can be performed more accurately.

The second acquirer 24 acquires a first body type parameter representing the body type of the first subject.

The second acquirer 24 acquires, for example, a first body type parameter entered by a user making an operation instruction on the input unit 16.

The display controller 39 displays, for example, an input screen for entering a first body type parameter representing the body type of the first subject on the display 20. The input screen includes, for example, fields for entering parameters such as a chest circumference, a waist circumference, a hip circumference, a height, and a shoulder width. The user then enters these values to the respective parameter fields by operating the input unit 16 while looking at the input screen displayed on the display 20. The input unit 16 outputs the input parameters to the second acquirer 24. The second acquirer 24 then acquires the first body type parameters by acquiring the parameters from the input unit 16.

The second acquirer 24 may estimate the first body type parameters of the first subject. In the example explained in the first embodiment, the second acquirer 24 estimates the first body type parameters of the first subject.

The second acquirer 24 includes a fifth acquirer 24A and an estimator 24B.

The fifth acquirer 24A acquires a depth map of the first subject. The fifth acquirer 24A reads a depth map of a first subject from the first subject image acquired by the third acquirer 26.

The depth map included in the first subject image acquired from the third acquirer 26 may include a background area other than a person area. The fifth acquirer 24A therefore acquires a depth map of a first subject, more specifically, by extracting a person area from the depth map read from the first subject image.

The fifth acquirer 24A extracts a person area, for example, by setting a threshold to a depth-direction distance of a three-dimensional position represented by each of the pixels making up the depth map. Let us assume herein that, in the coordinate system of the second imager 14B, for example, the point of origin is at the position of the second imager 14B, and the positive direction in the Z axis corresponds to the optical axis of the camera extending from the point of origin at the second imager 14B toward the subject. With such an assumption, a pixel of which depth-direction (Z-axis direction) coordinate is equal to or more than a predetermined threshold (for example, a value indicating two meters) is excluded from the pixels making up the depth map. In this manner, the fifth acquirer 24A acquires a depth map of the first subject that is a depth map consisting of pixels of a person area that is represented within a range of the threshold from the second imager 14B.

The estimator 24B estimates the first body type parameters of the first subject from the depth map of the first subject acquired by the fifth acquirer 24A.

The estimator 24B applies a piece of three-dimensional model data of a human body to the depth map of the first subject. The estimator 24B then calculates a value of each of the first body type parameters (e.g., a height, a chest circumference, a waist circumference, a hip circumference, and a shoulder width values) using the depth map and the three-dimensional model data applied to the first subject. In this manner, the estimator 24B estimates the first body type parameter of a first subject.

Specifically, the estimator 24B applies a piece of three-dimensional model data (three-dimensional polygon model) of a human body to the depth map of the first subject. The estimator 24B then estimates the measurements based on the distances of regions corresponding to the respective parameters (e.g., the height, the chest circumference, the waist circumference, the hip circumference, and the shoulder width) in the three-dimensional model data of a human body applied to the depth map of the first subject. Specifically, the estimator 24B calculates the value of each of the parameters such as the height, the chest circumference, the waist circumference, the hip circumference, and the shoulder width, based on the distance between two apexes or the length of an edge line connecting two apexes in the applied three-dimensional model data of a human body. The two apexes herein mean an end and the other end of a region corresponding to a parameter to be calculated (e.g., the height, the chest circumference, the waist circumference, the hip circumference, and the shoulder width) in the applied three-dimensional model data of a human body. A value of each of the second body type parameters of a second subject described later may be calculated in the same manner.

The fourth acquirer 28 acquires reference position information.

In the example explained hereunder in the first embodiment, the fourth acquirer 28 acquires a feature region, a contour line, and a feature point in the first subject image as reference position information.

The fourth acquirer 28 reads, for example, the color image of a first subject included in the first subject image acquired by the third acquirer 26. The fourth acquirer 28 then extracts a region corresponding to the shoulders (shoulder region) of a human body, for example, from the color image as a feature region. The fourth acquirer 28 further extracts the contour line from the extracted shoulder region as a feature region. A contour line is a linear image following the external shape of a human body. The contour line of the shoulder region therefore represents a linear image following the external shape of the shoulder region of a human body.

Any region of any parts (e.g., the shoulders or the hip) of a human body may be used when the feature region and the contour line are acquired. Identification information for indicating the region to be used when the feature region and the contour line are acquired may be stored in the storage 18 in advance. The fourth acquirer 28 can then use the region identified by the identification information stored in the storage 18 as a region from which the feature region and the contour line are acquired. The fourth acquirer 28 may use any known method to identify a region corresponding to such a region of a human body in the first subject image.

A feature point is calculated from skeleton information of a first subject, as an example. Skeleton information is a piece of information indicating the skeleton of a subject.

To acquire skeleton information, the fourth acquirer 28 reads, to begin with, the depth map of the first subject included in the first subject image acquired by the third acquirer 26. The fourth acquirer 28 then generates the skeleton information by applying a shape of a human body to the pixels making up the depth map of the first subject.

The fourth acquirer 28 then acquires the positions of the joints represented in the generated skeleton information as feature points. The fourth acquirer 28 may acquire the position at the center of the feature region as a feature point. In such a case, the fourth acquirer 28 may read and acquire the position at the center of the feature region from the skeleton information as a feature point. When the center of the shoulder region is used as a feature point, for example, the fourth acquirer 28 calculates and acquires the central position between the shoulders from the skeleton information as the feature point.

The first acquirer 22 acquires a first clothing image of a piece of clothing to be synthesized.

In the first embodiment, the first acquirer 22 acquires a first clothing image by extracting a clothing region from an image captured by and acquired from the imager 14.

For example, the imager 14 is caused to capture an image of the first subject or a third subject having the same body type as the first subject wearing the piece of clothing to be synthesized. The image captured by the imager 14 is output to the image processing apparatus 12. The first acquirer 22 acquires the captured image from the imager 14. The first acquirer 22 then extracts a clothing region from the captured image acquired from the imager 14. In this manner, the first acquirer 22 acquires the first clothing image.

The first acquirer 22 may also acquire the first clothing image from an external device not illustrated over a network or the like.

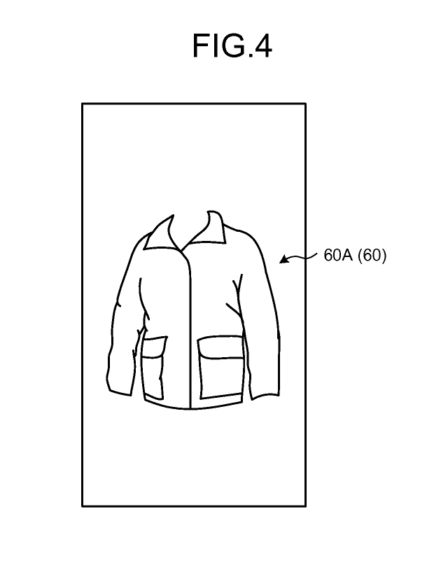

FIG. 4 is a schematic of an exemplary first clothing image 60. The first acquirer 22 acquires a first clothing image 60A as the first clothing image 60, as an example.

Referring back to FIG. 1, the storage controller 36 stores various types of data in the storage 18.

More specifically, the storage controller 36 stores a first subject image acquired by the third acquirer 26 in the clothing DB 18A, in a manner associated with the subject ID of the first subject image. The storage controller 36 also stores the reference position information in a first subject image acquired by the fourth acquirer 28 in the clothing DB 18A, in a manner associated with the first subject image. The storage controller 36 also stores a first body type parameter representing the body type of a first subject acquired by the second acquirer 24 in the clothing DB 18A, in a manner associated with the first subject image of the first subject.

The first subject image, the first body type parameter, and the reference position information are thus associated with one another in a one-to-one-to-one relation in the clothing DB 18A, as illustrated in FIG. 2.

Referring back to FIG. 1, the first generator 30 generates a second clothing image resulting from editing at least one of the size, the shape, and the position of the first clothing image.

In the first embodiment, the first generator 30 edits at least one of the size, the shape, and the position of the first clothing image with a first editing value. The first generator 30 edits at least one of the size, the shape, and the position of the first clothing image so that the resultant second clothing image is fitted to be worn by the first subject, for example.

The first generator 30, to begin with, calculates a first editing value. The first generator 30 calculates a first editing value that enables, for example, the first clothing image to be edited in such a manner that the clothing in the first clothing image is fitted to be worn by the first subject in the first subject image. The first generator 30 then edits at least one of the size, the shape, and the position of the first clothing image, using the calculated first editing value.

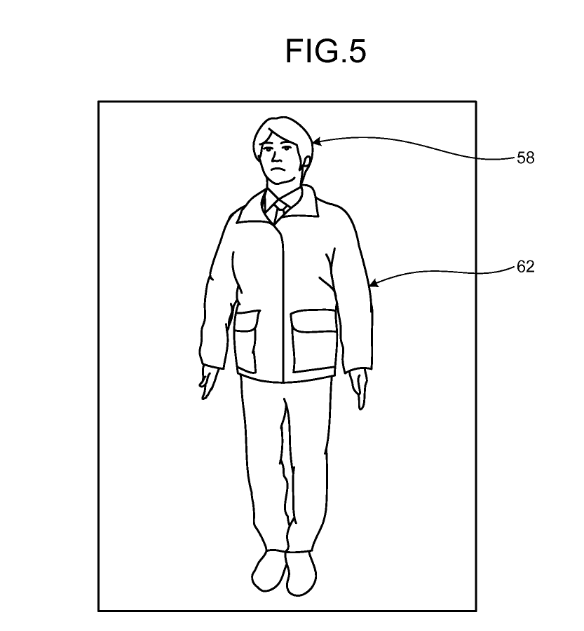

FIG. 5 is a schematic for explaining a second clothing image 62. As illustrated in FIG. 5, the first generator 30 calculates a first editing value that enables the first clothing image 60 to be edited (see FIG. 4) in such a manner that the first clothing image 60 is fitted to be worn by a first subject 58 in the resultant second clothing image 62. The first generator 30 then edits at least one of the size, the shape, and the position the first clothing image 60 (see FIG. 4) using the calculated first editing value, and generates the second clothing image 62.

Referring back to FIG. 1, the first generator 30 specifically enlarges or reduces the size of the first clothing image to edit the size of the first clothing image.

The first generator 30 applies a deformation to the first clothing image to edit the shape of the first clothing image. Examples of the deformation of the first clothing image include modifying the aspect ratio of the first clothing image, and deforming the first clothing image in such a manner that the clothing in the first clothing image appears as if the image is captured from a different angle in the resultant second clothing image.

The first editing value includes at least one of an enlargement or reduction ratio, a deformation ratio, a rotation angle, and a position offset width. The enlargement or reduction ratio is used in editing the size. The deformation ratio is used in editing the shape. The rotation angle represents an angle from which the image is captured, and is used in editing the shape. The position offset width is used in editing the position.

In other words, the first generator 30 calculates at least one of the enlargement or reduction ratio, the deformation ratio, the rotation angle, and the position offset width for the first clothing image, as the first editing value. The first generator 30 then edits at least one of the size, the shape, and the position of the first clothing image, using the calculated first editing value.

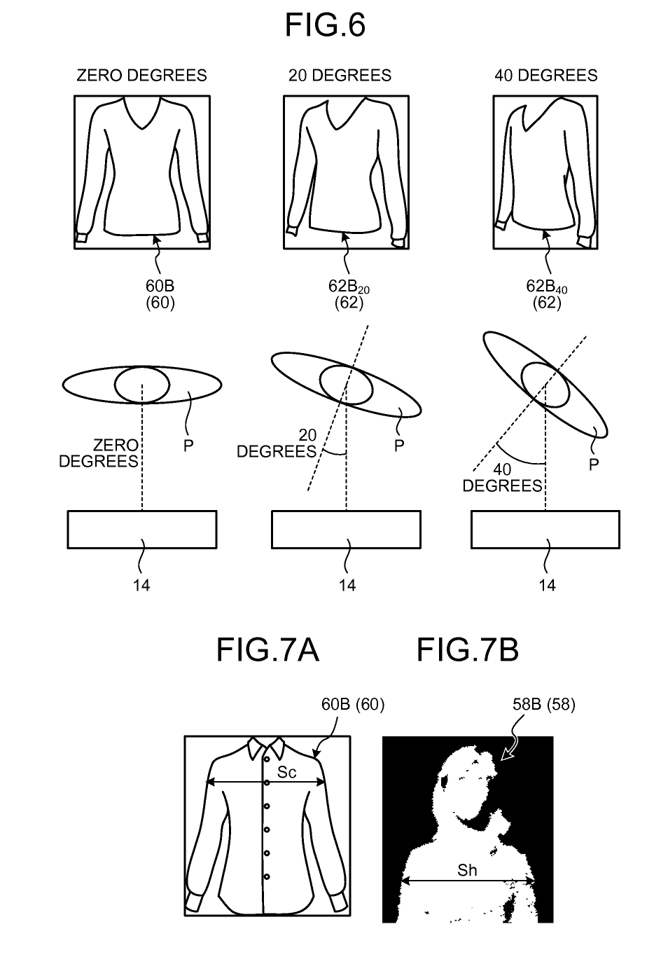

FIG. 6 is a schematic for explaining a rotation angle. The rotation angle is an angle of the first subject wearing the clothing in the first clothing image or the third subject wearing the clothing in the first clothing image with respect to the imager 14 of the time when the first clothing image is captured. The rotation angle in a captured image captured from the front side with respect to the imager 14 is “zero degrees”, for example. In other words, the clothing represented in a first clothing image 60B in the captured image is captured from a rotation angle of “zero degrees”.

For example, the first generator 30 generates a second clothing image 62B₂₀ that is the first clothing image 60 rotated by 20 degrees from the front side toward the right. For example, the first generator 30 generates a second clothing image 62B₄₀ that is the first clothing image 60 rotated by 40 degrees from the front side toward the right.

FIGS. 7A and 7B are schematics for explaining calculation of an enlargement or reduction ratio.

FIG. 7A is a schematic for explaining the first clothing image 60B. FIG. 7B is a schematic for explaining a first subject image 58B.

Let us assume herein that, as an example, the third acquirer 26 acquires a first subject image 58B as the first subject image 58 (see FIG. 7B), and the first acquirer 22 acquires a first clothing image 60B as the first clothing image 60 (see FIG. 7A). The first generator 30 calculates an enlargement or reduction ratio for the first clothing image 60B at which the clothing in the first clothing image 60B is represented as being worn by the first subject in the first subject image 58B.

More specifically, for example, the first generator 30 finds the Y coordinate of the pixel corresponding to the left shoulder and the Y coordinate of the pixel corresponding to the right shoulder, the shoulders included in the joints in the first subject image 58B, from the skeleton information of the first subject. The first generator 30 then looks for an X coordinate indicating the position of the border (contour line) of the clothing on the side of the left shoulder in the first subject image 58B, by performing retrieval along the position (height) of the acquired Y coordinate from the X coordinate of the pixel corresponding to the left shoulder toward the region outside of the first subject image 58B. The first generator 30 then looks for an X coordinate indicating the position of the border (contour line) of the clothing on the side of the right shoulder of the first subject image 58B, by performing retrieval along the position (height) of the acquired Y coordinate from the X coordinate of the pixel corresponding to the right shoulder toward the region outside of the first subject image 58B.

The first generator 30 can then calculate the shoulder width (the number of pixels) in the first subject image 58B by calculating the difference between these two X coordinates (see a shoulder length Sh in FIG. 7B).

The first generator 30 also performs the same process to the first clothing image 60B, thereby calculating the shoulder width (the number of pixels) in the first clothing image 60B (see a shoulder length Sc in FIG. 7A).

The first generator 30 then determines an enlargement or reduction ratio (scaling ratio) for the first clothing image 60B using the shoulder length Sc in the first clothing image 60B and the shoulder length Sh in the first subject image 58B. Specifically, the first generator 30 calculates the quotient resulting from dividing the shoulder length Sh in the first subject image 58B by the shoulder length Sc of the first clothing image 60B (Sh/Sc) as an enlargement or reduction ratio. The enlargement or reduction ratio may be calculated from a different operation.

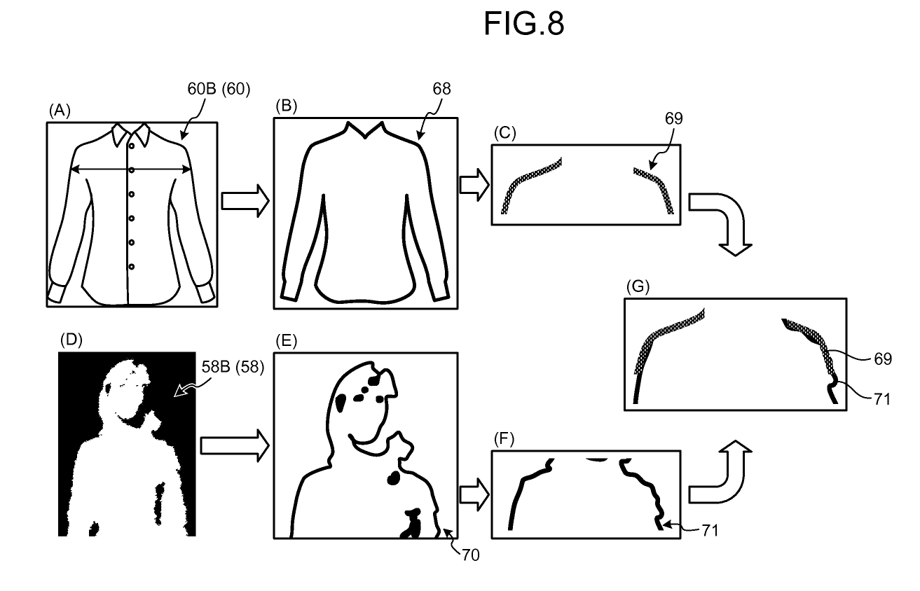

Calculation of a deformation ratio will now be explained. FIG. 8 is a schematic for explaining the calculation of the deformation ratio.

Let us assume herein that, as an example, the third acquirer 26 acquires the first subject image 58B (see part (D) in FIG. 8) as the first subject image 58, and the first acquirer 22 acquires the first clothing image 60B (see part (A) in FIG. 8) as the first clothing image 60.

The first generator 30 calculates a deformation ratio that enables the clothing in the first clothing image 60B to be represented as being worn by the first subject in the first subject image 58B, as a first editing value of the first clothing image 60B.

The first generator 30, for example, extracts the contour line 68 of the first clothing image 60B (see part (B) in FIG. 8). The first generator 30 then extracts the contour line 69 of the portion corresponding to the shoulders of a human body from the contour line 68, for example (see part (C) in FIG. 8).

Similarly, the first generator 30 extracts the contour line 70 of the first subject image 58B (see part (E) in FIG. 8). In the example illustrated in part (D) and part (E) in FIG. 8, the first generator 30 uses a depth map of the first subject as the first subject image 58B, but the first generator 30 may also use a color image of the first subject as the first subject image 58B.

The first generator 30 then extracts the contour line 71 of the portion corresponding to the shoulders of a human body from the contour line 70, for example (see part (F) in FIG. 8).

The first generator 30 then performs template matching with the contour line 69 of the portion corresponding to the shoulders in the first clothing image 60B and the contour line 71 of the portion corresponding to the shoulders in the first subject image 58B (see part (G) in FIG. 8). The first generator 30 then calculates a deformation ratio for the contour line 69 at which the shape of the contour line 69 matches the shape of the contour line 71. The first generator 30 uses the calculated deformation ratio as the deformation ratio for editing the first clothing image 60B.

Referring back to FIG. 1, it is preferable for the first generator 30 to edit the first clothing image using a first editing value falling within a first range so that the condition is satisfied.

The first range is a piece of information specifying a possible range (the upper limit and the lower limit) of the first editing values.

The first range is a range in which the visual features of the clothing in the first clothing image are not lost by editing. In other words, the first range defines the upper limit and the lower limit of the first editing value so that the first editing value falls within a range in which the visual features of the clothing in the first clothing image are not lost by editing.

The design, the patterns, the shape, and the like that are the visual features of the clothing in the first clothing image might get lost when the first clothing image is edited by the first generator 30.

It is therefore preferable to establish a first range in which the visual features of the clothing in the first clothing image are not lost by the editing. By allowing the first generator 30 to generate a second clothing image that is a first clothing image edited with a first editing value falling within the first range, the resultant second clothing image can be used effectively as a clothing image to be synthesized.

The storage 18 then stores therein the first range in a manner associated with the clothing type, for example. The first range may be set in advance for each of the clothing types. The first range and the association between the first range and the clothing type can be modified as appropriate, via a user operation instruction made on the input unit 16. The first acquirer 22 then may acquire the first clothing image, and the clothing type of the clothing in the first clothing image from the input unit 16. The clothing type may be entered by a user making an operation instruction on the input unit 16. The first generator 30 may read the first range corresponding to the clothing type acquired by the first acquirer 22 from the storage 18, and use the first range in editing the first clothing image.

When a plurality of second clothing images are superimposed, the first range may be a range enabling the lower layer second clothing image to be smaller in size than the area of the upper layer second clothing image. A plurality of second clothing images can be used, for example, when generated is a synthetic image representing a subject wearing pieces of clothing on top of one another or in combination. If the second clothing image placed on the lower layer is larger than the size of the second clothing image placed on the upper layer, a natural-looking synthetic image can be rarely be achieved. When the second clothing images are to be superimposed, therefore, the first range may be a range in which the lower layer second clothing image is smaller in sizes than the area of the upper layer second clothing image.

When such a range is used, for example, the storage 18 stores therein the first range in a manner associated with a clothing type and the order in which the pieces of clothing are superimposed. The order in which clothing pieces of clothing are layered is a piece of information indicating which pieces of clothing is most commonly wore in which layer when these pieces of clothing are put on a human body or the like in a layered manner, from the lowest layer where the clothing touches the human body toward upper layers away from the human body. The first range is a range falling within the area of the upper second layer, when the corresponding pieces of clothing are worn in their respective layers.

The clothing type, the order for layering the clothing, and the first range may be changed as appropriate, by a user making an operation instruction on the input unit 16. When the first clothing image is acquired, the first acquirer 22 may also acquire the clothing type of the clothing in the first clothing image and the order for layering the clothing from the input unit 16. The clothing type and the order for layering the clothing may be entered by a user making an operation instruction on the input unit 16. The first generator 30 may then read the first range corresponding to the clothing type the order of layering the clothing acquired by the first acquirer 22 from the storage 18, and use the first range when the first generator 30 edits the first clothing image.

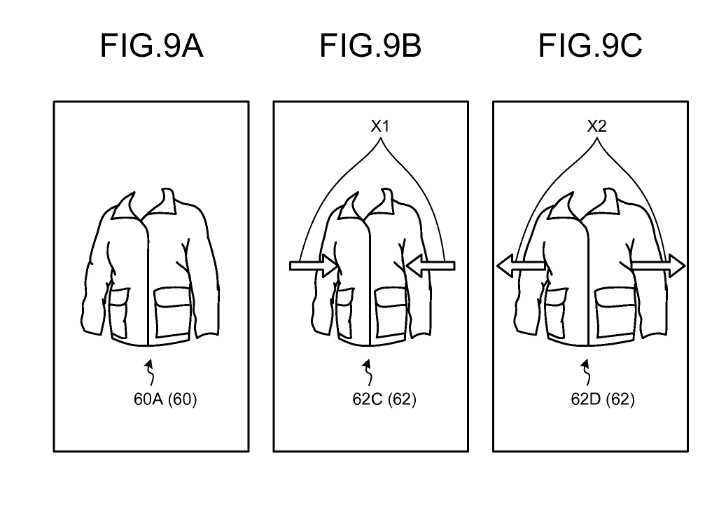

FIG. 9A is a schematic of an example of the first clothing image 60, and FIGS. 9B and 9C are schematics of examples of second clothing images 62. It is assumed herein that, as an example, the first clothing image 60A illustrated in FIG. 9A is the first clothing image 60. The first generator 30 edits the first clothing image 60A using the first editing value. As an example, the first generator 30 may generate a second clothing image 62C (see FIG. 9B) by deforming the first clothing image 60A (see FIG. 9A) in the directions of the arrows X1 illustrated in FIG. 9B. As another example, the first generator 30 may also generates a second clothing image 62D (see FIG. 9C) by deforming the first clothing image 60A (see FIG. 9A) in the directions of arrow X2 in FIG. 9C.

When the position is edited by the first generator 30, the first generator 30 may change the position of the first clothing image 60A in the captured image.

The first generator 30 may edit the size or the shape of the entire first clothing image 60A. The first generator 30 may also divide the first clothing image 60A into a plurality of regions (e.g., into rectangular regions), and edit the size or shape of each of the regions. Each of such regions may be assigned with the same first editing value or different first editing values. For example, the regions corresponding to the sleeves of a piece of clothing may be deformed to a larger aspect ratio, than that of the other regions. The first generator 30 may also edit by means of free-form deformation (FFD).

In the manner described above, the first generator 30 generates a second clothing image 62 by editing at least one of the size, the shape, and the position of the first clothing image 60.

Referring back to FIG. 1, the storage controller 36 stores the second clothing image 62 in the storage 18.

More specifically, when the first generator 30 generates a second clothing image 62 from the first clothing image 60, using first editing value, the storage controller 36 stores the generated second clothing image 62 in the clothing DB 18A, in a manner associated with the first subject image used in calculating the first editing value.

Every time the first generator 30 generates a second clothing image 62 from a first clothing image 60 of a piece of clothing identified by a new clothing ID, using a corresponding first editing value, the storage controller 36 stores the generated second clothing image 62 in the clothing DB 18A, in a manner associated with the first subject image used in calculating the first editing value. The first generator 30 may also edit the clothing with the same clothing ID with different first editing values, thereby generating a plurality of second clothing images corresponding to the respective first editing values from the same first clothing image. The storage controller 36 may then store the second clothing images generated by the editing in the clothing DB 18A, in a manner associated with the first subject images used in calculating the respective first editing values.

As a result, a plurality of second clothing images 62 comes to be associated with a first subject image, a first body type parameter, and a piece of reference position information in the clothing DB 18A, as illustrated in FIG. 2.

Referring back to FIG. 1, the second generator 32 edits the first subject image 58 using a second editing value in such a manner that a second subject who is in the resultant second subject image has a body type represented by a second body type parameter that is different from the first body type parameter of the first subject.

For example, the second generator 32 generates a second subject image of a second subject having a body type represented by a second body type parameter that is different from the first body type parameter, by editing at least one of the size and the shape of the first subject image 58. The definitions of the size and the shape are the same as those described above.

Specifically, the second generator 32 edits at least one of the size and the shape of the first subject image 58, using a second editing value. For example, the second generator 32 edits the size of the first subject image 58 by enlarging or reducing the size of the first subject image 58.

The second generator 32 also edits the shape of the first subject image 58 by deforming the first subject image 58. Examples of the deformation of the first subject image 58 includes modifying the aspect ratio of the first subject image 58, and deforming the first subject in the first subject image 58 in such a manner that the first subject in the resultant second subject image appears as if the image is captured from another angle.

The second editing value includes at least one of an enlargement or reduction ratio, a deformation ratio, and a rotation angle. The definitions of the enlargement or reduction ratio, the deformation ratio, and the rotation angle are the same as those of the first editing value.

The second generator 32 calculates a second editing value enabling the first subject image 58 to be edited in such a manner that the second subject in the resultant second subject image has a second body type parameter that is different from the first body type parameter of the first subject. The second generator 32 then edits at least one of the size and the shape of the first subject image 58 using the calculated second editing value, to generate a second subject image.

It is preferable for the second generator 32 to edit the first subject image 58 using a second editing value falling within a predetermined second range so that the condition described above is satisfied.

The second range is a piece of information specifying a range (the upper limit and the lower limit) of the second editing value.

The second range is a range that is expected in a human body. In other words, the second range defines a possible range of second editing values allowing the first subject in the first subject image 58 to be edited to a body type within an expectable range in a human body. It is preferable for the second range to be a range not causing the visual features of the clothing to be lost when the first subject image 58 wearing the clothing is edited. It is therefore preferable to set the second range accordingly to the first range.

With the second range, for example, a clothing type, a first range, and a second range are stored in a manner associated with to each other in the storage 18 in advance. The first range and the second range may be established for each of the clothing types in advance. The first range, the second range, and the association between the first range, the second range, and the clothing type may be modified as appropriate by a user making an operation instruction on the input unit 16, for example. When the first clothing image is acquired, the first acquirer 22 may also acquire the clothing type of the clothing in the first clothing image from the input unit 16. The second generator 32 then reads the second range associated with the clothing type acquired by the first acquirer 22 and the first range used by the first generator 30 from the storage 18. The second generator 32 may then generate a second subject image by editing the first subject image 58 using a second editing value falling within the read second range so as that the condition described above is satisfied.

Using the second editing value and the first subject image used in generating the second subject image, the third generator 34 calculates a second body type parameter representing the body type of the second subject in the second subject image, and the reference position information corresponding to the second subject image from the first body type parameter and the reference position information corresponding to the first subject image.

More specifically, the third generator 34 reads the second editing value and the first subject image used in generating the second subject image. The third generator 34 then reads the first body type parameter and the reference position information associated with the first subject image from the clothing DB 18A (see FIG. 2). The third generator 34 then edits the first body type parameter and the reference position information corresponding to the first subject image, using the second editing value. In this manner, the third generator 34 calculates a second body type parameter representing the body type of the subject in the second subject image and the reference position information corresponding to the second subject image.

Once the second subject image is generated, the storage controller 36 stores the second subject image in the storage 18. More specifically, the storage controller 36 stores the generated second subject image in a manner associated with the subject ID of the first subject image 58 from which the second subject image is resulted by editing in the clothing DB 18A (see FIG. 2).

Once the second body type parameter corresponding to the second subject image and the reference position information corresponding to the second subject image are calculated, the storage controller 36 stores the second body type parameter and the reference position information in the clothing DB 18A, in a manner associated with the second subject image (see FIG. 2).

As a result, one subject ID is associated with one first subject image, and to one or more second subject images as subject images in the clothing DB 18A, as illustrated in FIG. 2. A second body type parameter and a piece of reference position information are associated with a second subject image, in a one-to-one-to-one relation.

Referring back to FIG. 1, the third generator 34 generates a third clothing image by editing the second clothing image 62 using the second editing value used in generating the second subject image. In other words, the third generator 34 generates a third clothing image by enlarging or reducing the size of the second clothing image 62 using the enlargement or reduction ratio, or deforming the second clothing image 62 with the deformation ratio, the ratios specified as the second editing value.

The third generator 34 may edit the size or the shape of the entire second clothing image, in the same manner as the first generator 30. The third generator 34 may also divide the second clothing image into a plurality of regions (e.g., into rectangular regions), and edit the size or the shape of each of the regions. The second editing value of each of the regions may be the same or different. The third generator 34 may also perform the edition by means of FFD.

Once the third clothing image is generated by the third generator 34, the storage controller 36 stores the third clothing image in the storage 18.

More specifically, the storage controller 36 reads the second editing value used in generating the third clothing image. The storage controller 36 then stores the third clothing image in a manner associated with the second subject image having generated with the second editing value in the clothing DB 18A.

As a result, one first subject image and one or more second subject images as subject images are associated with one subject ID in the clothing DB 18A, in the manner described above, as illustrated in FIG. 2. In the clothing DB 18A, one second subject image, one second body type parameter, and a piece of reference position information are associated with a plurality of third clothing image. As described earlier, a set of one first subject image, one first body type parameter, and a piece of reference position information is associated with a plurality of second clothing images. A second clothing image is a clothing image generated by editing the corresponding first clothing image. A third clothing image is a clothing image generated by editing the corresponding second clothing image.

The storage controller 36 may store the second editing value used in generating the third clothing image in the storage 18, instead of the third clothing image. In such a case, the storage controller 36 stores the second editing value in a manner associated with the second subject image. In such a case, the third generator 34 may not generate the third clothing image.

The image processing performed by the image processing apparatus 12 according to the first embodiment will now be explained.

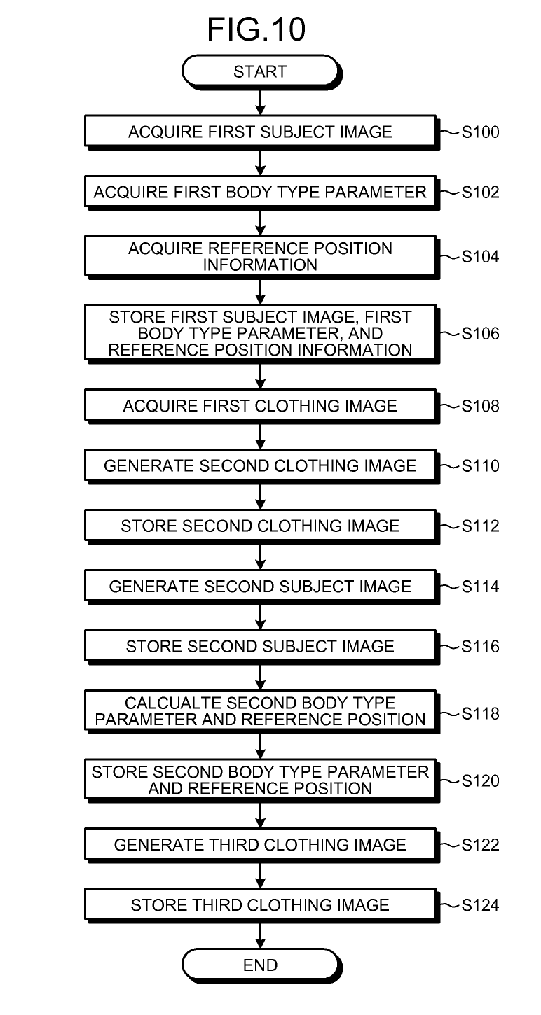

FIG. 10 is a flowchart of the image processing performed by the image processing apparatus 12.

To begin with, the third acquirer 26 acquires the first subject image (Step S100). The second acquirer 24 then acquires the first body type parameter representing the body type of the first subject image (Step S102). The fourth acquirer 28 then acquires the reference position information in the first subject image (Step S104). The storage controller 36 stores the first subject image, the first body type parameter, and the reference position information in the clothing DB 18A, in a manner associated with the subject ID (Step S106). As a result, the first subject image, the first body type parameter, and the reference position information are associated with each other in a one-to-one-to-one relation in the clothing DB 18A, as illustrated in FIG. 2.

The first acquirer 22 acquires a first clothing image (Step S108). The first generator 30 then generates a second clothing image by editing the first clothing image acquired at Step S108 using a first editing value (Step S110). The storage controller 36 then stores the second clothing image generated at Step S110 in the storage 18, in a manner associated with the first subject image acquired at Step S100, the first body type parameter acquired at Step S102, and the reference position information acquired at Step S104 (Step S112).

In this manner, the second clothing image is associated with one first subject image, one first body type parameter, and a piece of reference position information in the clothing DB 18A, as illustrated in FIG. 2. The image processing apparatus 12 executes the process from Step S100 to Step S110 every time a first clothing image of a piece of clothing identified by a different clothing ID is acquired. As a result, one subject ID is associated with one first subject image, one first body type parameter, a piece of reference position information, and a plurality of second clothing images in the clothing DB 18A, as illustrated in FIG. 2.

Referring back to FIG. 10, the second generator 32 then generates a second subject image from the first subject image stored in the storage 18, using a second editing value (Step S114). The storage controller 36 then stores the second subject image generated at Step S114 in the clothing DB 18A, in a manner associated with the subject ID of the first subject image from which the second subject image is generated (Step S116) (see FIG. 2).

Using the second editing value used in generating the second subject image at Step S114 and the first subject image, the third generator 34 then calculates a second body type parameter representing the body type of the second subject in the second subject image and the reference position information in the second subject image from the first body type parameter and the reference position information corresponding to the first subject image (Step S118).

The storage controller 36 then stores the second body type parameter and the reference position calculated at Step S118 in the clothing DB 18A, in a manner associated with the second subject image generated at Step S114 (Step S120) (see FIG. 2).

The third generator 34 then generates a third clothing image by editing the second clothing image generated at Step S110, using the second editing value used at Step S114 (Step S122). The storage controller 36 then stores the third clothing image generated at Step S122 in the clothing DB 18A, in a manner associated with the second subject image generated at Step S114 (Step S124) (see FIG. 2). The routine is then ended.

The storage controller 36 may store the second editing value used at Step S114 in a manner associated with the second subject image generated at Step S114 in the clothing DB 18A, instead of the third clothing image, as mentioned earlier. In such a case, it is not necessary to perform the process of generating the third clothing image at Step S122 and the process of storing at Step S124.

After the image processing apparatus 12 performs the process from Step S100 to Step S124, the clothing DB 18A will be as illustrated in FIG. 2, for example. In other words, a first subject image, a first body type parameter, and a piece of reference position information are stored in the clothing DB 18A, in a manner associated with one or more second clothing images. One first subject image and one or more second subject images are also associated with one subject ID, and stored in the clothing DB 18A. A second subject image, a second body type parameter, and a piece of reference position information are stored in the clothing DB 18A, in a manner associated with one or more third clothing images.

As described above, the image processing apparatus 12 according to the first embodiment includes the first acquirer 22, the first generator 30, and the storage controller 36. The first acquirer 22 acquires a first clothing image of a piece of clothing to be synthesized. The first generator 30 generates a second clothing image by editing at least one of the size, the shape, and the position of the first clothing image. The storage controller 36 then stores the second clothing image in the storage 18.

In the manner described above, the image processing apparatus 12 according to the first embodiment stores a second clothing image resulting from editing at least one of the size, the shape, and the position of a first clothing image of a piece of clothing to be synthesized in the storage 18, instead of storing the first clothing image itself in the storage 18.

When the clothing image is then synthesized to a subject image, therefore, the synthetic image can be generated from the second clothing image, without performing various editions to the first clothing image.

The image processing apparatus 12 according to the first embodiment can therefore provide a clothing image enabled to simplify the synthesizing process.

Furthermore, the first generator 30 generates a second clothing image by editing at least one of the size, the shape, and the position of a first clothing image, using a first editing value falling within a first range. In this manner, by setting a limitation to the first editing value used in editing the first clothing image, it becomes possible to provide a clothing image with which a more natural-looking synthetic image can be produced, in addition to the advantageous effect described above.

Furthermore, it is preferable for the first range to be a range not causing the visual feature of the clothing in the first clothing image to be lost. By setting the first range to such a range, it becomes possible to provide a clothing image with which a more natural-looking synthetic image can be produced, in addition to the advantageous effect described above.

Furthermore, when a plurality of second clothing images are superimposed, it is preferable for the first range to allow a lower layer second clothing image to be smaller in the size than the area of an upper layer second clothing image. By setting the first range to such a range, it becomes possible to provide a clothing image with which a more natural-looking synthetic image can be produced, in addition to the advantageous effect described above.

The image processing apparatus 12 according to the first embodiment also include the second acquirer 24. The second acquirer 24 acquires the first body type parameter representing the body type of the first subject. The first generator 30 edits the first clothing image so that the clothing in the first clothing image is represented as being worn by the first subject in the resultant second clothing image.

The image processing apparatus 12 can therefore provide a clothing image allowing generation of a synthetic image representing a subject of a certain body type trying on the piece of clothing.

Furthermore, the first generator 30 edits the shape of the first clothing image so that the clothing in the first clothing image appears as if the image is captured from a different direction in the resultant second clothing image. The subject image to which a clothing image is synthesized is not limited to an image acquired by taking a picture of the subject from a particular camera angle. By causing the first generator 30 to edit the shape of the first clothing image so that the clothing in the first clothing image appears as if the image is captured from a different angle in the resultant second clothing image, a clothing image enabled to simplify the synthesizing process can be provided.

Furthermore, the image processing apparatus 12 according to the first embodiment includes the third acquirer 26, the second generator 32, and the third generator 34. The third acquirer 26 acquires a first subject image of a first subject. The third generator 34 edits the first subject image using a second editing value so that the resultant body type represented by the second body type parameter in the resultant second subject image becomes different from that represented by the first body type parameter of the first subject. The third generator 34 generates a third clothing image by editing the second clothing image using the second editing value. The storage controller 36 then stores the third clothing image in the storage 18.

The image processing apparatus 12 can therefore easily generate a third clothing image corresponding to a second body type parameter, using the generated second clothing image.

As mentioned earlier, the storage controller 36 may store the second editing value used in generating the second subject image in the clothing DB 18A, instead of the third clothing image. By storing the second editing value in the clothing DB 18A instead of the third clothing image, the amount of data in the clothing DB 18A can be reduced.

The second generator 32 generates a second subject image by editing the first subject image, using a second editing value falling within a predetermined second range. In this manner, by setting a limitation to the second editing value used in editing the second clothing image, it becomes possible to provide a clothing image with which a more natural-looking synthetic image can be produced, in addition to the advantageous effect described above.

Furthermore, the image processing apparatus 12 according to the first embodiment includes the fourth acquirer 28. The fourth acquirer 28 acquires reference position information in the first subject image of the first subject with a first body type parameter, the reference position information used in aligning positions before synthesizing. The storage controller 36 then stores the pair of the first body type parameter and the reference position information, and a plurality of second clothing images in the storage 18, in a manner associated with each other.

Conventionally, the reference position information or the like used in aligning the positions before synthesizing has been calculated for each clothing image. The corresponding clothing image and the subject image are then aligned and synthesized using the reference position information calculated for each of a plurality of clothing images. Let us consider an example in which generated is a synthetic image in which a subject is trying on a plurality of pieces of clothing in a combination, or a synthetic image in which a subject is trying on a plurality of pieces of clothing on top of one another.

Conventionally, to achieve these images, the position of the subject image has been aligned with that of each of clothing images, using the reference position information of each of the clothing images. The resultant clothing images synthesized to the subject image often have some misalignment respect to each other, and it has conventionally been difficult to provide a synthetic image presenting a natural-looking image of the subject trying on these pieces of clothing.

By contrast, in the image processing apparatus 12 according to the first embodiment, the reference position information is stored for each body type parameter representing a body type of the subject, not for each piece of clothing, in the clothing DB 18A. A pair of a first body type parameter and a piece of reference position information is then stored in a manner associated with a plurality of second clothing images in the clothing DB 18A.

The image processing apparatus 12 according to the first embodiment can therefore provide a clothing image capable of producing a synthetic image presenting a more natural-looking image of the subject trying on pieces of clothing.

Furthermore, the second generator 32 generates a second subject image by editing the first subject image using a second editing value. The second generator 32 edits the first body type parameter and the corresponding reference position information using the second editing value. In this manner, the second generator 32 generates a second body type parameter and reference position information corresponding to the second subject image. The third generator 34 generates a third clothing image by editing the second clothing image using the second editing value. The storage controller 36 stores these pieces of information in a manner associated with each other in the clothing DB 18A.

As a result, a set of one second subject image, one second body type parameter, and a piece of reference position information is stored in a manner associated with a plurality of third clothing images in the clothing DB 18A.

By generating a synthetic image of the subject image with a clothing image using the reference position information corresponding to the second clothing image or the third clothing image, a more natural-looking synthetic image of the subject trying on pieces of clothing can be provided.

In other words, the image processing apparatus 12 according to the first embodiment can provide a clothing image capable of producing a synthetic image presenting a more natural-looking view of the subject trying on pieces of clothing.

### Second Embodiment

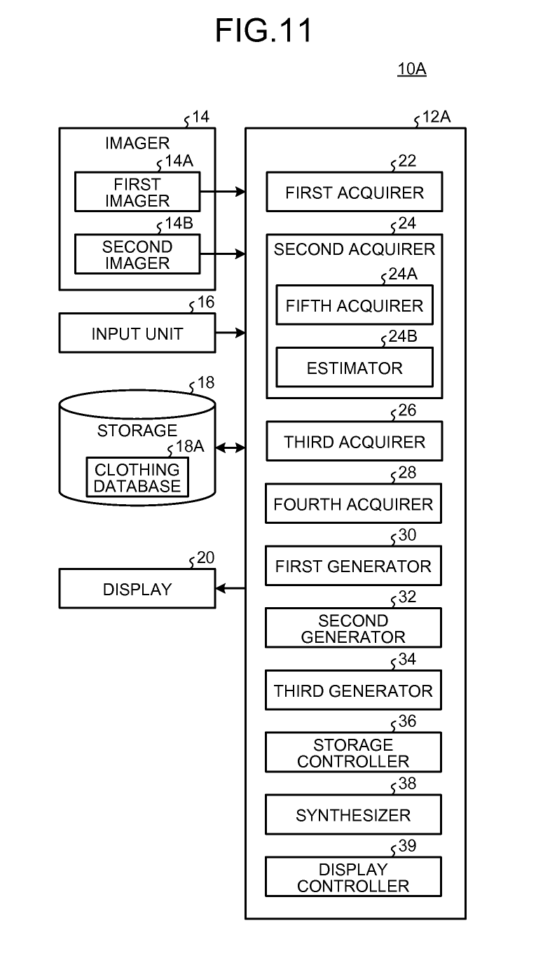

FIG. 11 is a block diagram of the functional configuration of an image processing system 10A according to a second embodiment.

The image processing system 10A includes an image processing apparatus 12A, the imager 14, the input unit 16, the storage 18, and the display 20. The imager 14, the input unit 16, the storage 18, and the display 20 are connected to the image processing apparatus 12A in a manner enabling signals to be exchanged. The imager 14, the input unit 16, the storage 18, and the display 20 are the same as those according to the first embodiment.

The image processing apparatus 12A is a computer including a central processing unit (CPU), a read-only memory (ROM), and a random access memory (RAM). The image processing apparatus 12A may include any other circuit other than a CPU.

The image processing apparatus 12A includes the first acquirer 22, the second acquirer 24, the third acquirer 26, the fourth acquirer 28, the first generator 30, the second generator 32, the third generator 34, the storage controller 36, the display controller 39, and a synthesizer 38.

The first acquirer 22, the second acquirer 24, the third acquirer 26, the fourth acquirer 28, the first generator 30, the second generator 32, the third generator 34, the storage controller 36, the display controller 39, and the synthesizer 38 may be implemented entirely or partially by causing a processor such as a CPU to execute a computer program, that is, implemented as software, as hardware such as an integrated circuit (IC), or as a combination of software and hardware.

The image processing apparatus 12A is the same as the image processing apparatus 12 according to the first embodiment except that the synthesizer 38 is further provided.

The synthesizer 38 synthesizes a subject image to be synthesized with a clothing image to be synthesized.

The synthesizer 38 acquires the subject image to be synthesized from the imager 14. The synthesizer 38 may acquire the subject image to be synthesized from an external device or the like not illustrated, over a network. The subject image to be synthesized may be the first subject image or the second subject image used in the first embodiment.

The synthesizer 38 uses a clothing image (a second clothing image or a third clothing image) stored in the clothing DB 18A, as explained in the first embodiment, as a clothing image to be synthesized.

More specifically, the synthesizer 38 receives a selection of a clothing image to be synthesized, among the second clothing images and the third clothing images stored in the clothing DB 18A, from the input unit 16. The user enters, for example, a clothing ID, attribute information of the clothing, or the like by making an operation instruction on the input unit 16.

The synthesizer 38 retrieves the clothing DB 18A for at least one of a second clothing image and a third clothing image corresponding to the clothing ID or the attribute information received from the input unit 16. The display controller 39 then controls to display a list of at least one of the retrieved one or more second clothing images and third clothing images on the display 20.

Once the list of clothing images is displayed on the display 20, the user selects the clothing image of a piece of clothing to be synthesized, from the list of clothing images displayed on the display 20, by making an operation instruction on the input unit 16. The input unit 16 then outputs the identification information that uniquely identifies the clothing image selected by the user to the image processing apparatus 12A. The synthesizer 38 acquires the identification information of the clothing image to be synthesized from the input unit 16, and reads the clothing image (second clothing image or third clothing image) corresponding to the identification information from the clothing DB 18A.

The synthesizer 38 then synthesizes the subject image to be synthesized and the clothing image to be synthesized (the second clothing image or the third clothing image).

Because a second clothing image and a third clothing image are results of editing a first clothing image captured by the imager 14, as explained in the first embodiment, the synthesizer 38 can generate a synthetic image of the subject image and the clothing image without performing various types of editing to the clothing image to be synthesized (the second clothing image or the third clothing image).

The image processing apparatus 12A according to the second embodiment can therefore simplify the synthesizing process, in addition to the advantageous effects achieved in the first embodiment.

The image processing apparatus 12A according to the second embodiment uses a clothing image (a second clothing image or a third clothing image) stored in the clothing DB 18A, as explained in the first embodiment, as a clothing image to be synthesized.

The image processing apparatus 12A according to the second embodiment can therefore generates a more natural-looking synthetic image.

The synthesizer 38 also aligns the positions of the images using the reference position information of the clothing image to be synthesized (a second clothing image or a third clothing image) before generating a synthetic image.

If the reference position information includes a feature region, as an example, the synthesizer 38 aligns the positions of the clothing image and the subject image so that the feature region in the clothing image to be synthesized (a second clothing image or a third clothing image) is matched with the feature region in the subject image to be synthesized before the synthetic image is generated.

As explained in the first embodiment, the storage controller 36 stores the reference position information for each body type parameter representing a body type of a subject, not for each piece of clothing in the clothing DB 18A. A plurality of clothing images including at least one of the second clothing images and the third clothing images are then stored in a manner associated with a pair of one body type parameter and the corresponding piece of reference position information in the clothing DB 18A.

The synthesizer 38 can therefore generate a more natural-looking synthetic image of the subject trying on pieces of clothing by generating a synthetic image of the clothing image with the subject image using the reference position information corresponding to the second clothing images or to the third clothing images.

### Third Embodiment

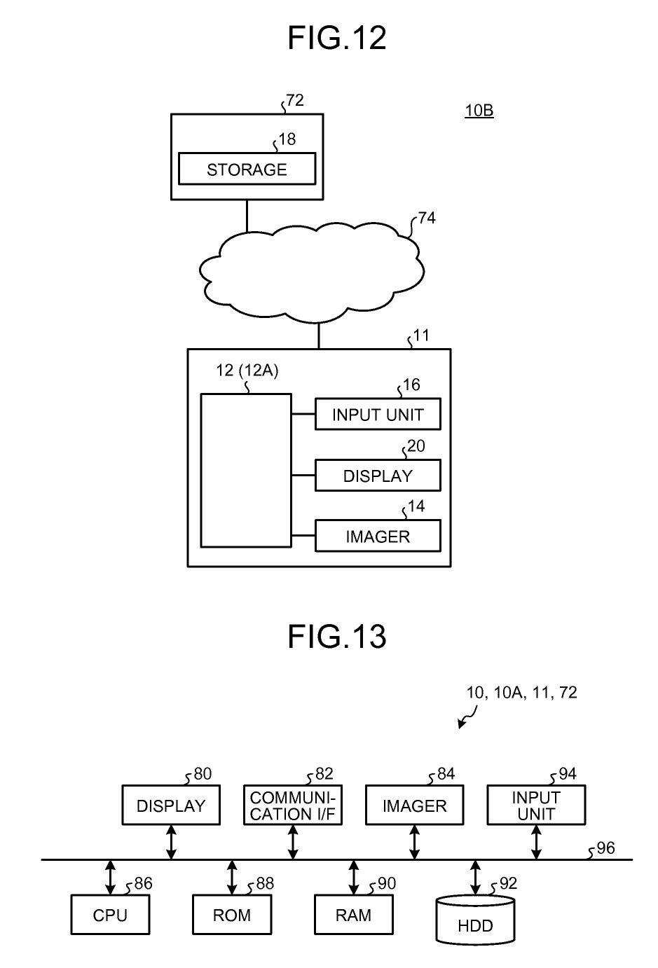

FIG. 12 is a schematic illustrating an image processing system 10B.

In the image processing system 10B, a storage device 72 and a processing device 11 are connected over a communication line 74.

The storage device 72 is a device including the storage 18 according to the first embodiment, and is a personal computer of a known type, for example. The processing device 11 is a device provided with the image processing apparatus 12, the imager 14, the input unit 16, and the display 20. The functional units that are the same as those in the first embodiment are assigned with the same reference numerals, and detailed explanations thereof are omitted hereunder. The communication line 74 is a communication line such as the Internet, examples of which include a wired telecommunication circuit and a wireless telecommunication circuit.

The processing device 11 may include the image processing apparatus 12A according to the second embodiment instead of the image processing apparatus 12 according to the first embodiment.

As illustrated in FIG. 12, the storage 18 is provided to the storage device 72 connected to the processing device 11 over the communication line 74. This configuration allows a plurality of processing devices 11 to access the same storage 18, and the data stored in the storage 18 to be centrally managed.

### Fourth Embodiment

The hardware configurations of the image processing system 10, the image processing system 10A, the processing device 11, and the storage device 72 according to the first to the third embodiments will now be explained. FIG. 13 is a block diagram illustrating an exemplary hardware configuration of the image processing system 10, the image processing system 10A, the processing device 11, and the storage device 72.

The image processing system 10, the image processing system 10A, the processing device 11, and the storage device 72 each include a display 80, a communication interface (I/F) 82, a imager 84, an input unit 94, a CPU 86, a read-only memory (ROM) 88, a random access memory (RAM) 90, and a hard disk drive (HDD) 92 connected to each other over a bus 96, and each have a hardware configuration implemented as a general computer.

The CPU 86 is a processor that controls the entire process performed by the image processing system 10, the image processing system 10A, the processing device 11, and the storage device 72. The RAM 90 stores therein data required in various processes performed by the CPU 86. The ROM 88 stores therein computer programs or the like implementing various processes performed by the CPU 86. The HDD 92 stores therein data to be stored in the storage 18. The communication I/F 82 is an interface for establishing a connection to an external device or an external terminal over a telecommunication circuit, for example, and exchanging data with the connected external device or external terminal. The display 80 corresponds to the display 20 described above. The imager 84 corresponds to the imager 14 described above. The input unit 94 corresponds to the input unit 16 described above.

The storage device 72 may not include the imager 84. More specifically, the communication I/F 82, the CPU 86, the ROM 88, and the RAM 90 correspond to the hardware of the image processing apparatus 12, the image processing apparatus 12A, and the storage device 72.

The computer program for executing various processes performed by the image processing apparatus 12 and the image processing apparatus 12A in the image processing system 10, the image processing system 10A, the processing device 11, and the storage device 72 is embedded and provided in, for example, the ROM 88 in advance.

The computer program executed according to the first to the third embodiments may be recorded and provided in a computer-readable recording medium such as a compact disc read only memory (CD-ROM), a flexible disk (FD), a compact disc recordable (CD-R), and a digital versatile disc (DVD), as a file that can be installed to and executed on such a device.

The computer program executed according to the first to the third embodiments may be stored in a computer connected to a network such as the Internet and made available for a download over the network. The computer program for implementing the various processes performed by the image processing apparatus 12 and the image processing apparatus 12A according to the first to the third embodiments may be provided or distributed over a network such as the Internet.

The computer program for implementing the various processes according to the first to the third embodiments generates the units described above on the main memory.

Various types of information stored in the HDD 92, that is, the various types of information stored in the storage 18 may also be stored in an external device (such as a server). In such a configuration, the external device and the CPU 86 may connect to each other over a network, for example.

The applicable scope of the image processing apparatus 12, and the image processing apparatus 12A according to the embodiments described above is not limited to the examples described above. The image processing apparatus 12 and the image processing apparatus 12A may be provided to, for example, devices installed in stores, or may be internalized in electronic devices such as mobile terminals, personal computers, and televisions. The image processing apparatus 12 and the image processing apparatus 12A may also be used in electronic blackboard systems (signage systems).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a first acquirer configured to acquire a first clothing image of a piece of clothing to be synthesized;
a first generator configured to generate a second clothing image by editing at least one of a size, a shape, and a position of the piece of clothing in the first clothing image; and
a storage controller configured to store the second clothing image in a storage.

2. The apparatus according to claim 1, wherein the first generator generates the second clothing image by editing at least one of the size, the shape, and the position of the piece of clothing in the first clothing image using a first editing value falling within a first range.

3. The apparatus according to claim 2, wherein the first range is a range in which visual features of the clothing in the first clothing image is not lost.

4. The apparatus according to claim 2, wherein the first range is a range in which, when a plurality of second clothing images are superimposed, a lower layer second clothing image is smaller in size than an area of an upper layer second clothing image.

5. The apparatus according to claim 2, further comprising:
a second acquirer configured to acquire a first body type parameter representing a body type of a first subject, wherein
the first generator edits the first clothing image so that the clothing in the first clothing image is represented as being worn by the first subject in the second clothing image.

6. The apparatus according to claim 1, wherein the first generator edits the first clothing image so that the clothing in the first clothing image appears to have been captured from a different angle in the second clothing image.

7. The apparatus according to claim 5, further comprising:
a third acquirer configured to acquire a first subject image of the first subject; and
a fourth acquirer configured to acquire reference position information in the first subject image, the reference position being used in aligning positions before synthesizing, wherein
the storage controller stores the first body type parameter and the reference position information in the storage, in a manner associated with a plurality of second clothing images each of which has a different piece of clothing or a different first editing value.

8. The apparatus according to claim 5, further comprising:
a third acquirer configured to acquire a first subject image of the first subject;
a second generator configured to generate a second subject image by editing the first subject image using a second editing value in such a manner that a body type is represented by a second body type parameter that is different from the first body type parameter in the second subject image; and
a third generator configured to generate a third clothing image by editing the second clothing image using the second editing value, wherein
the storage controller stores the third clothing image in the storage.

9. The apparatus according to claim 5, further comprising:
a third acquirer configured to acquire a first subject image of the first subject; and
a second generator configured to generate a second subject image by editing the first subject image using a second editing value in such a manner that a body type is represented by a second body type parameter that is different from the first body type parameter in the second subject image, wherein
the storage controller stores the second editing value in the storage.

10. The apparatus according to claim 8, wherein the second generator generates the second subject image by editing the first subject image using the second editing value falling within a second range.

11. The apparatus according to claim 9, wherein the second generator generates the second subject image by editing the first subject image using the second editing value falling within a second range.

12. The apparatus according to claim 1, further comprising the storage.

13. The apparatus according to claim 1, wherein the position of the piece of clothing in the first clothing image include a feature region, a contour line, and a feature point.

14. An image processing system comprising:
an image processing apparatus; and
an external device connected to the image processing apparatus over a network, wherein
the image processing apparatus comprises:
a first acquirer configured to acquire a first clothing image of a piece of clothing to be synthesized;
a first generator configured to generate a second clothing image by editing at least one of a size, a shape, and a position of the piece of clothing in the first clothing image; and
a storage controller configured to store the second clothing image in a storage, and
the external device comprises the storage.

15. An image processing method comprising:
acquiring a first clothing image of a piece of clothing to be synthesized;
generating a second clothing image by editing at least one of a size, a shape, and a position of the piece of clothing in the first clothing image; and
storing the second clothing image in a storage.
